(19) United States
(12) Patent Application Publication
(10) Pub. No.: US 2014/0052537 A1
(43) Pub. Date: Feb. 20, 2014

(54) Information Display System for Transit Vehicles

(71) Applicant: MODOOH INC., Concord (CA)

(72) Inventors: Jason Garnet, Thornhill (CA); Kevin Dochstader, Guelph (CA)

(73) Assignee: MODOOH INC., Concord (CA)

(21) Appl. No.: 13/623,464

(22) Filed: Sep. 20, 2012

(30) Foreign Application Priority Data
Aug. 17, 2012 (CA) 2786205

(51) Int. Cl. G06Q 30/02; G08G 1/123

(52) U.S. Cl. 705/14.63; 340/996

(57) ABSTRACT

Systems and methods for providing location-based advertising on transit vehicles comprising the installation of one or more digital displays capable of displaying advertisements, wherein the advertisement displayed is controlled by a media player that determines the advertisements to be played based on the current time and location of the transit vehicle. Through the use of the system, the displayed advertisement can be selected based on the geographical location of the transit vehicle on its route. Additionally, through the use of digital displays, the advertisements displayed can be rotated throughout the transit vehicle to allow both more individual advertisements to be displayed on a single vehicle and to allow riders to view more advertisements while on the transit vehicle.

### FIELD OF THE INVENTION

The present invention relates to a system for displaying targeted information, for example, advertising, on digital displays within public transportation (transit) vehicles.

### BACKGROUND OF THE INVENTION

Public transportation vehicles, also referred to as transit vehicles, for example, buses, streetcars, tramways, light rail transit, subways and trains, are commonly used advertising platforms. Traditionally, advertisements within transit vehicles are static displays located within a band running the length of the vehicle above the windows. This band of advertisements is divided into segments, with each segment providing a different advertisement. Alternatively, advertisements may be posted in the walls or partitions within the transit vehicles where space permits.

However, this traditional form of advertising suffers many disadvantages, including that each of the advertisements may only be changed when the transit vehicle is out of service, the advertisement remains the same throughout the route of the vehicle, and any given advertisement is only visible to the riders that are within close proximity within the vehicle. A further disadvantage is that this form of advertising creates large amounts of waste every time the advertisement is replaced, particularly in the case of large fleets of transit vehicles. More importantly, however, this form of advertising makes it difficult for local advertisers to target their advertising to riders within the proximity of their business and, as a result, their advertisements are displayed to riders regardless of the geographical location of the transit vehicle on the route. This affects the value that advertisers are willing to pay for advertising space in the transit vehicle and the attention that riders pay to the advertising itself.

More recently, advertisements within transit vehicles have also included the use of video monitors. Thus, a series of advertisements can be displayed on an ongoing cycle throughout the transit vehicle. However, whether a given advertisement is viewed by a rider depends on the length of time that the rider spends on the transit vehicle and their proximity to the video monitors within the vehicle.

Various systems have been developed to attempt to respond to the disadvantages with traditional advertising methods.

An early attempt at providing location-directed advertising is described in WO 91/014247, which described a system for controlling and updating information announced to passenger within a mass transit vehicle based on the location of a vehicle on its route. However, the information to be provided to transit riders is delivered audibly or on a digital display in the form of static or streaming text. This form of display requires the transit rider to constantly view the display screen to follow the advertisement, and is therefore an impractical method for the provision of product information, including graphics or location information, relating to the product and advertiser.

U.S. Pat. No. 7,449,998 describes electronic display panels for taxi cabs that use the geographical location of the vehicle to display location-based targeted advertising. However, the panels are not visible to the passenger in the taxi cab. As a result, the advertisements are able to be viewed by pedestrians only for a short period of time, and when the vehicle is moving at slow enough speeds for the advertisement to be viewed clearly.

United States Patent Application No. 2007/0100698 describes an adaptive advertising system that can change the displayed content in response to external inputs, such as the time of day, weather conditions, or, in the case of transit vehicles, a past or upcoming transit station. However, this system relates to the use of playlists that are triggered by the vehicle location, which limits the flexibility for changing advertisements.

United States Patent Application No. 2007/0118860 describes a mobile video delivery system for vehicles intended for use as an adjunct to a video surveillance system involving a vehicle, a means of determining the location of the vehicle, a display and a memory or storage units. Although advertisements can be displayed based on the proximity of the vehicle to an advertiser, the system itself involves a single monitor, and there provides a limited ability for riders to view the advertisements themselves or a range of advertisements at the same time.

United States Patent Application No. 2002/0069017 describes a system for notifying passengers waiting for public transit vehicles of the status of the vehicles that includes placing a position determining device on a transit vehicle that transmits the vehicle location to display devices at transit stops, displays on transit vehicles or to mobile devices used by transit riders. A further embodiment of the system also provides news and advertisements that can be geared to the location of the vehicle, time of day, season or weather. However, in this system, the provision of advertising information on transit vehicles is adjunctive to the provision of the information relating to information on upcoming stops, points of interest, transfer connections and arrival times.

As a result, there is a need for an improved system to provide advertising within transit vehicles that provides advertisements directed to the riders or passengers in the vehicle and whose content is dependent on the geographical location of the vehicle.

### SUMMARY OF THE INVENTION

The present system provides an improved method of providing location-based advertisement on transit vehicles by integrating the present location of the transit vehicle with the advertisement that is displayed to the rider.

Accordingly, in one aspect of the present invention there is provided a system for providing location-based information on transit vehicles, the system comprising:
(a) One or more digital displays located in the transit vehicle and viewable by passengers in the transit vehicle, the one or more digital displays capable of displaying the location-based information;
(b) A media player to control the information that is displayed on the one or more digital displays; and
(c) A location sensing device located on the transit vehicle to communicate the geographical location of the transit vehicle to the media player,
wherein the media player selects the location-based information to be displayed on the one or more digital displays depending on the geographical location of the vehicle.

Optionally, the system may also comprise further components, including storage devices, sending/receiving capabilities to central control systems, analytic capabilities, and rider-interactive features.

In another aspect of the present invention, there is provided a system for providing location-based advertisements on transit vehicles, the system comprising:
(a) One or more digital displays located in the transit vehicle and viewable by passengers in the transit vehicle, the one or more digital displays capable of displaying the location-based information and comprising one or more digital cameras for the collection of analytic data regarding the passengers viewing the location-based advertisements displayed on the one or more digital displays;
(b) A media player to control the information that is displayed on the one or more digital displays;
(c) A location sensing device located on the transit vehicle to communicate the geographical location of the transit vehicle to the media player; and
(d) Storage means for storing the collected analytic data regarding the passengers,
wherein the media player selects the location-based information to be displayed on the one or more digital displays depending on the geographical location of the vehicle.

In another aspect of the present invention, there is provided a system for providing location-based advertisements on transit vehicles, the system comprising:
(a) One or more digital displays located in the transit vehicle and viewable by passengers in the transit vehicle, the one or more digital displays capable of displaying the location-based information and comprising one or more digital cameras for the collection of analytic data regarding the passengers viewing the location-based advertisements displayed on the one or more digital displays;
(b) A media player to control the location-based advertisements that is displayed on the one or more digital displays; and
(c) A location sensing device located on the transit vehicle to communicate the geographical location of the transit vehicle to the media player;
wherein the media player selects the location-based information to be displayed on the one or more digital displays depending on the geographical location of the vehicle and the collected analytic data.

In another aspect of the present invention, there is provided a system for providing information on transit vehicles, the system comprising:
(a) An array comprising two or more digital displays arranged lengthwise within the array, wherein the array is located in the transit vehicle,
(b) Each of the two or more digital displays is viewable by passengers in the transit vehicle and is capable of displaying the information; and
(c) A media player to control the information that is displayed on the two or more digital displays.

In another aspect of the present invention, there is provided a system for providing information on transit vehicles, the system comprising:
(a) An array comprising two or more digital displays arranged lengthwise within the array, wherein the array is located in the transit vehicle;
(b) A media player to control the location-based information that is displayed on the one or more digital displays;
(c) A remote control centre that is in communication with the media player to provide the location-based information to the media player; and
(d) A location sensing device located on the transit vehicle to communicate the geographical location of the transit vehicle to the media player,
wherein the media player selects the location-based information to be displayed on the one or more digital displays depending on the geographical location of the vehicle.

In a further aspect of the invention, there is provided a method of displaying location-based information on one or more digital displays located within a transit vehicle and viewable by riders in the transit vehicle, the method comprising:
(a) Determining the current geographical location, and optionally the current time, of the transit vehicle;
(b) Accessing a database of location-based information and associated scheduling information to select location-based information having scheduling information that is associated with the current geographical location, and optionally the current time, of the transit vehicle; and
(c) Displaying the selected location-based information on the one or more digital displays for a specified period of time depending on the scheduling information associated with the selected location-based information.

In a further aspect of the invention, there is provided a method of displaying location-based information on one or more digital displays located within a transit vehicle and viewable by riders in the transit vehicle, the method comprising:
(a) Determining the current geographical location, and optionally the current time, of the transit vehicle;
(b) Accessing a database of location-based information and associated scheduling information to select location-based information having scheduling information that is associated with the current geographical location, and optionally the current time, of the transit vehicle; and
(c) Displaying the selected location-based information on the one or more digital displays on a rotating basis amongst the digital displays in the array for a specified period of time depending on the scheduling information associated with the selected location-based information.

In a further aspect of the invention, there is provided a method of displaying location-based advertising on one or more digital displays located within a transit vehicle and viewable by riders in the transit vehicle, the method comprising:
(a) Determining the current geographical location, and optionally the current time, of the transit vehicle;
(b) Accessing a database of location-based information and associated scheduling information to select location-based advertising having scheduling information that is associated with the current geographical location, and optionally the current time, of the transit vehicle;

(c) Displaying the selected location-based advertising on the one or more digital displays for a specified period of time depending on the scheduling information associated with the selected location-based advertising;
(d) Collecting and storing analytic data regarding the riders viewing the selected advertisement; and
(e) Transmitting the collected or stored analytic data to the advertiser.

In a further aspect of the invention, there is provided a method for allowing advertisers to select advertisements to be displayed on one or more digital displays located on a transit vehicle and viewable by riders on the transit vehicle, the method comprising:
(a) Providing a central media database containing a plurality of stored advertisements capable of being displayed on the one or more digital displays, each stored advertisement having associated information regarding geographic location and time period;
(b) Determining the current geographical location, and optionally the current time, of the transit vehicle;
(c) Transmitting the current geographical location, and optionally the current time, of the transit vehicle to the central media database;
(d) Selecting one of the stored advertisements whose associated data corresponds to the current geographical location, and optionally the current time, of the transit vehicle;
(e) Transmitting the selected advertisement to a local media database located on the transit vehicle; and
(f) Displaying the selected advertisement on the one or more digital displays.

### BRIEF DESCRIPTION OF THE DRAWINGS

Embodiments of the present invention are described, by way of example only, with reference to the attached Figures.

FIG. 1 provides sectional views of a subway car with an array of digital displays as a continuous band installed above the windows and running the length of the car.

FIG. 2 provides a sectional view of a subway car showing an array of digital displays as a continuous band installed above the windows and running the length of the transit vehicle.

FIGS. 3A, 3B, 3C, 3D, 3E, and 3F provide views of a preferred shape of digital display for use with the present invention.

FIGS. 4A, 4B and 4C provide a sectional view of a transit vehicle with an array of digital displays showing advertisements displayed over a period of time.

FIG. 5A provides an advertisement scheduling algorithm for a system of the present invention.

FIG. 5B provides an advertisement scheduling algorithm for a system of the present invention utilizing digital displays with digital cameras for the collection of analytic data.

FIG. 6 provides a schematic of a scheduling process for the system of the present invention.

### DETAILED DESCRIPTION OF THE INVENTION

The use of public transportation or transit vehicles, for example, buses, streetcars, tramways, light rail transit, subways and trains, as advertising platforms is well known. However, this form of advertising is inefficient in many ways. For example, the advertisement content on a given transit vehicle cannot be changed without removing the transit vehicle from service to manually replace the currently used static advertisements, which are typically printed on a polymeric or plastic substrate, and which must then either be stored or disposed of, requiring either large amounts of storage space for a fleet of transit vehicles or a large amount of waste disposal on a routine basis. Additionally, the advertisements currently displayed within transit vehicles are static, both in terms of their location on the transit vehicle and in terms of the geographic location of the transit vehicle itself.

The present invention provides a solution to these known problems by providing a system for providing advertisement content on digital displays located within transit vehicles and viewable by riders in the transit vehicle, wherein the advertisements that are displayed are selected based on the current time and present geographical location of the transit vehicle. Optionally, the advertisements are cycled throughout an array of digital displays within the transit vehicle in order to maximize both the number of riders that can view the selected advertisement and the number of advertisements that can be displayed throughout the vehicle at a given time.

In its most basic form, a first aspect of the present invention provides a system for providing location-based advertisements on transit vehicles, the system comprising:
(a) One or more digital displays located in the transit vehicle and viewable by passengers in the transit vehicle, the one or more digital displays capable of displaying the location-based advertisements;
(b) A media player to control the location-based advertisements that is displayed on the one or more digital displays; and
(c) A location sensing device located on the transit vehicle to communicate the geographical location of the transit vehicle to the media player,
wherein the media player selects the location-based advertisements to be displayed on the one or more digital displays depending on the geographical location of the vehicle.

Optionally, as discussed in further detail below, the system may also comprise further components, including storage devices, sending/receiving capabilities to central control systems, analytic capabilities, and rider-interactive features.

Thus, further aspects of the present invention include a system as described above, further comprising:
(a) The one or more digital displays each comprise one or more digital cameras for collecting analytic data regarding the riders who are viewing the one or more digital displays, wherein the collected analytic data is collected and provided to the advertiser;
(b) The one or more digital displays each comprise one or more digital cameras for collecting analytic data regarding the riders who are viewing the one or more digital displays, wherein the collected analytic data can be used to further select the advertisement to be displayed on the one or more digital displays based on the riders viewing or within range of the digital displays; or
(c) A remote control centre that can update the content and scheduling of advertisements, wherein the remote control communicates with the media player on a transit vehicle through wireless communication.

A transit vehicle in which the system of the present invention may be used is any type of vehicle in which people are transported. While a preferred use of the system is in vehicles used for mass transportation, for example, buses, streetcars, subways, light rail trains (LRTs) and commuter trains, the system can also be used in taxis and rental cars.

While the present system is directed primarily to the delivery of location-based advertisements to riders within transit vehicles, the system may also be used to deliver location-based advertisements on the exterior of the transit vehicle in the same manner, with external digital displays controlled by the same, or a secondary, media player.

When multiple digital displays are used in the present system, it is preferred, although not required, that the displays are centrally controlled by a single media player, thereby forming a network or array of displays, rather than to have each display controlled individually. The use of a central controller reduces both the cost and complexity of the system within the transit vehicle by eliminating the need for each display to have its own media player. The use of a central controller also allows for the coordination of the advertisements being displayed amongst the network or array of displays.

The digital displays can be any form of screen capable of displaying digital content. Preferably, the display will be some form of LED (light-emitting diode), OLED (organic light-emitting diode), LCD (liquid crystal display), or plasma display. Although any sized display can be used in the present system, the displays will ideally be sized to be installed in the traditional advertising spaces within transit vehicles, most commonly on the space extending the length of the vehicle or car above the windows, and also on the available space on the walls or partitions in the vehicles. For example, displays can be sized to have an approximate dimension of 70 inches in length, 11 inches in width, and 2 inches in depth for a flat screen or 70 inches in length, 11 inches in width, and 4 inches in depth for a concave screen, thus approximating a standard advertisement size used in the space above the windows of transit vehicles.

For digital displays to be mounted in the traditional advertisement space running the length of the vehicle above the windows, the digital displays may be either flat-screens or curved-screens. Digital displays may also be provided in less traditional areas in the transit vehicle, including the ceilings of the vehicle/car or seatbacks.

Optional features for the digital displays include the use of protective glass (e.g. CORNING® GORILLA® Glass), anti-graffiti film, autostereoscopic 3-D, backlighting, auto dimming capabilities to adjust the brightness of the display based on the environmental conditions within the vehicle and application, NFC (near-field communication) or related interfaces, and digital cameras.

Although the inclusion of digital cameras within the digital displays is intended primarily for use with analytics, an optional use of the digital cameras would allow transportation owners or municipal authorities to take over control of the cameras and/or entire digital displays in emergency situations. This would allow authorities to monitor emergency situations on individual transit vehicles via the digital cameras, as well as to communicate with riders of the transit vehicle through the digital displays. Although not practical, or desired by riders, the one or more digital displays within a transit vehicle may be equipped with speakers and/or microphones for providing a further communication means between authorities and the riders during emergency situations.

The digital displays themselves can be arranged as continuous bands to give the appearance of a single long display, or they may be arranged as discreet units. In addition to the use in displaying content, the digital displays can also include an optional LED light band to replace the existing lighting (generally fluorescent lighting with the associated ballast) to both reduce energy consumption and the reduce the cost of maintaining and disposing of the associated waste across a fleet of vehicles. Additionally or alternatively, LED bands associated with the digital displays can be used for emergency purposes and powered independently from the digital displays by back-up batteries located on the bus.

Digital displays may also be incorporated into the system of the present invention in various configurations. For example, each digital display can display the same single advertisement at the same time or the digital displays can be configured to display different, multiple advertisements. The latter option is particularly useful when considering digital displays arranged in the band space above the windows that run the length of the vehicle or car. Through the use of extended-length digital displays capable of displaying multiple advertisements, the number of digital displays required per car may be reduced. Additionally, the size of an advertisement does not need to be restricted to a specific length. Further, advertisements can be scheduled to be cycled throughout the transit vehicle rather than remaining static on a single display, as is required with current transit advertising.

In addition to their ability to display the advertising content, the digital displays may also be associated with additional features, including analytics and rider-interaction features.

Analytic features that may be used or associated with the digital displays include one or more digital cameras for use with facial analytic software (for example, the INTEL® AIM (Audience Impression Metrics) Suite). Through the use of analytics, information regarding the riders viewing the advertisements may be collected and thereafter transmitted to the advertisers, optionally as a further revenue stream; advertisements can be further targeted to the current riders who are in proximity a particular digital display; advertising costs can be tied to the number of riders in proximity to the digital display over time; and information can be collected by the advertisers to assess the effectiveness of a given advertisement in terms of the attention paid to the advertisement by transit riders. Further, advertisers can use analytics to refine the content of the advertisement itself.

Through the inclusion of analytic components in the digital displays, the advertisements to be displayed at a given geographic location and/or time can be further targeted based on the riders currently viewing advertisements and/or within the viewing area of a given digital display. Thus, for example, if a majority of riders viewing a given digital display are women, the advertisements displayed on that particular display can be biased towards those that are targeted towards women as opposed to those that are targeted towards men. Additionally, if the analytic software determines that there are riders in the viewing area of a particular digital display but they are not paying attention to the advertisement being displayed, or paying less attention over time, alternative advertisements can be selected and displayed in an effort to attract or re-attract the attention of the riders.

Rider-interaction features may also be incorporated with the digital displays, such as touch capable interfaces (for example, touch screen displays), wireless interfaces (for example, Wi-Fi™ 802.11b/g/n/ac, bluetooth, near-field communication (NFC) or other wireless technology) and related interfaces.

Touch screen displays are well known and are more suited to digital displays mounted on walls/partitions of the transit vehicles or on seatback displays since they are more easily accessible to the rider to physically touch the screen. The use of touchscreen displays allows the rider to interact with the advertisement being displayed, for example, to get further information on a particular advertisement. Use of a touchscreen could be used, for example, to display supplementary information about the product or service being advertised, enlarged or alternative images, or videos. Further, the use of touchscreens would also allow riders to provide feedback on the displayed advertisements, or would allow the riders to be polled or surveyed. The incorporation of wireless interface technology, such as Wi-Fi™, bluetooth, NFC or similar technology within the digital displays allows riders within close proximity of the displayed advertisement to use their smartphones or similarly equipped devices to obtain further information about the product or service being advertised, for example, by providing links to websites or coupons.

It will also be understood that the advertisements displayed on the digital displays may also incorporate rider-interaction features, such as, for example, QR (quick response) codes, TAG codes, or UPC (Universal Product Code)-type barcodes, which are already common in traditional advertising on transit vehicles, and can be scanned using the rider's smartphone or similar device to provide additional information about the product or service being advertised, such as links to websites, information on store locations, or downloadable coupons.

The media player for use in the preferred system of the present invention is configured to control when a given advertisement is displayed on a given digital display within the transit vehicle. Thus, the media player comprises one or more central processing units (CPUs), memory means, storage media (for example, a hard drive) for both the advertisement content and the collection of analytic data (if the system installed is capable of collecting analytic data), graphic processors, an internal clock, and the means to determine the geographical location of the transit vehicle at a given time, for example, a GPS (Global Positioning System) or a related or alternative positioning system that provides the media player with the geographical position of the vehicle at a given time. Preferably, the media player can control multiple digital displays located on the transit vehicle. The media player will also have associated with it a means to update the content of the media database and advertisement scheduling. Preferably, this means is provided by a wireless interface (for example, Wi-Fi™ 802.11b/g/n/ac, cellular interface, bluetooth, satellite, or other wireless technology) to a central control centre, but may also be provided manually by physically replacing the media database in the media device of a vehicle or by updating the contents of the database, for example, by data transfer from a USB (Universal Serial Bus) key or similar means.

Each digital display is operatively connected to the media player, either directly, where each digital display is connected to the media player through a suitable connection for the transmission of data, or indirectly, where a first digital display is connected to the media player and the remaining digital displays are interconnected to the first digital display

In addition to the media player, the preferred system of the present invention may also incorporate a remote control centre comprising a central server that controls the advertisements displayed in one or more transit vehicles via a wireless network on a real-time basis rather than requiring that the advertisement and scheduling be updated manually for a fleet of transit vehicles. The central server can include a remote media database for storing a plurality of advertisements that are currently displayed in the transit vehicles as well as storing older advertisements so that they can be rescheduled to run as desired by advertising clients. As in the case of the local media database located on the transit vehicle, the remote media database can also store the current scheduling information associated with each advertisement.

As a result of the ability of the preferred system of the present invention to update the advertisement displayed in the transit vehicle remotely and in real-time, the system may also provide public information, emergency updates or safety information to riders by interrupting the advertisement display schedule in order to display the announcements, either on individual digital displays or by scrolling across all or a part of the array of digital displays. For example, when a continuous array of digital displays is used, the content being displayed can scroll continuously across the array of digital displays. Alternatively, the size of the advertisement currently being displayed can be temporarily reduced to provide space to display other messages to the riders. Similarly, selected digital displays within the transit vehicle can be used to display current news updates, including sports scores and stock updates instead of advertisements.

As an alternative embodiment of the system of the present invention, the media player located on the transit vehicle controls only the display of advertisements on the digital displays, whereas the central server remotely selects which advertisements are to be displayed in specific transit vehicles based on the geographical location of the vehicle, which is continuously, or at stated intervals, transmitted to the central server. However, in this embodiment, advertisement content cannot be updated when communications between the transit vehicle and the central server are interrupted.

The preferred system of the present invention is described in further detail with reference to the figures as follows.

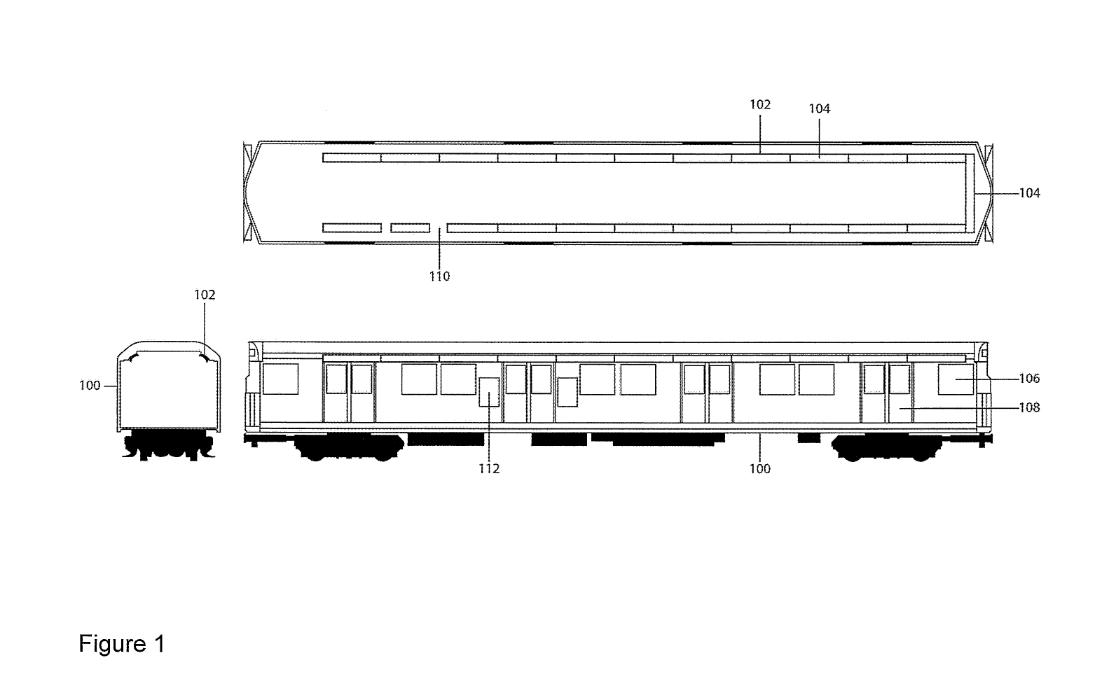

FIG. 1 provides sectional views of a transit vehicle 100, for example, a subway car, in which an array or band 102 of digital displays 104 has been installed running the length of vehicle 100 above the windows 106 and/or doors 108. Alternatively, the array 102 can comprise of a series of digital displays 104 that are separated by gaps 110. In addition to array 102, wall displays 112 may also be installed within the vehicles.

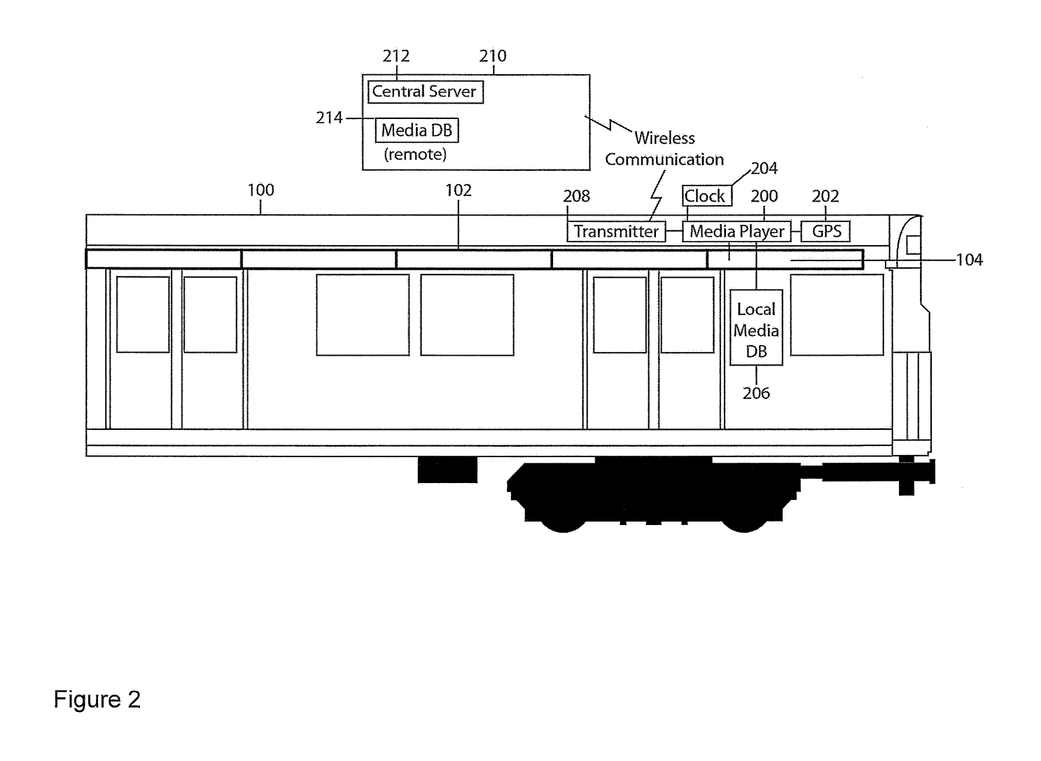

As shown in FIG. 2, the digital displays 104 of the array 102 are connected to a media player 200 that controls the advertisements displayed on the digital displays 104 via communication with a location positioning device 202, for example a GPS device, and a clock 204. Advertisements themselves may be stored on a local media database 206. In a preferred optional embodiment, the media player 200 communicates wirelessly through a transmitter 208 with a control centre 210, which includes a central server 212 and remote media database 214. The use of control centre 210 allows for media and advertisement content to be updated or controlled remotely, thus eliminating the need to update the media database and scheduling parameters on each vehicle individually.

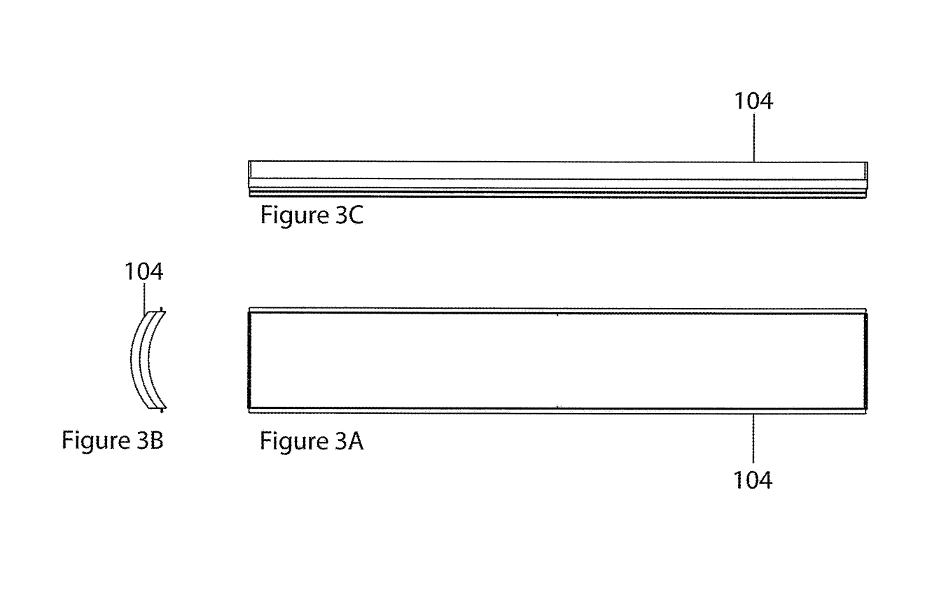

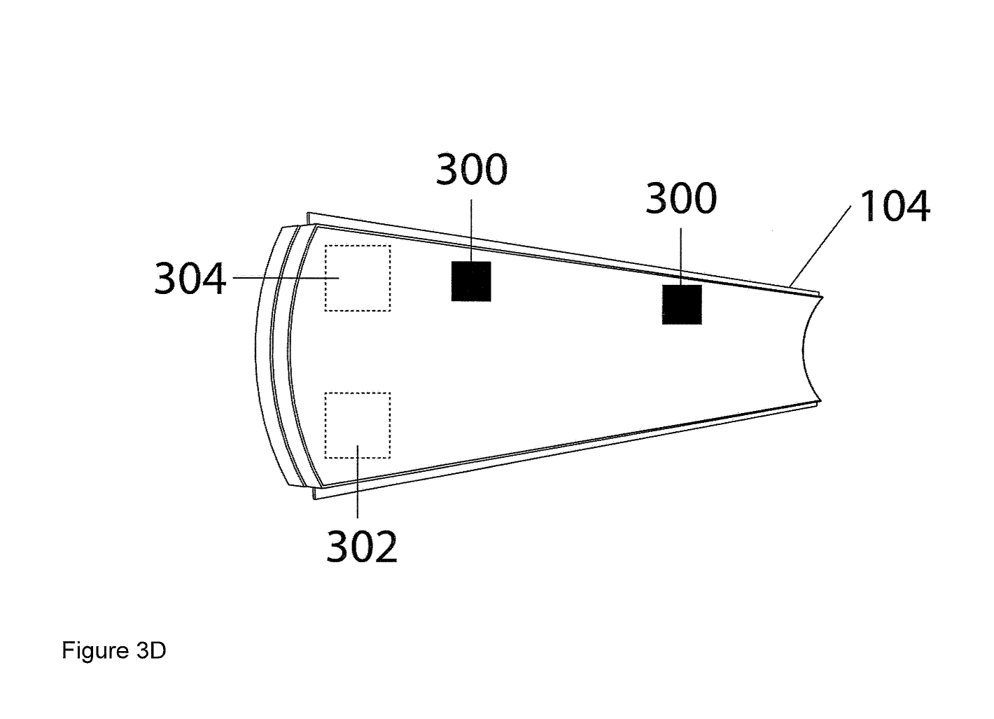

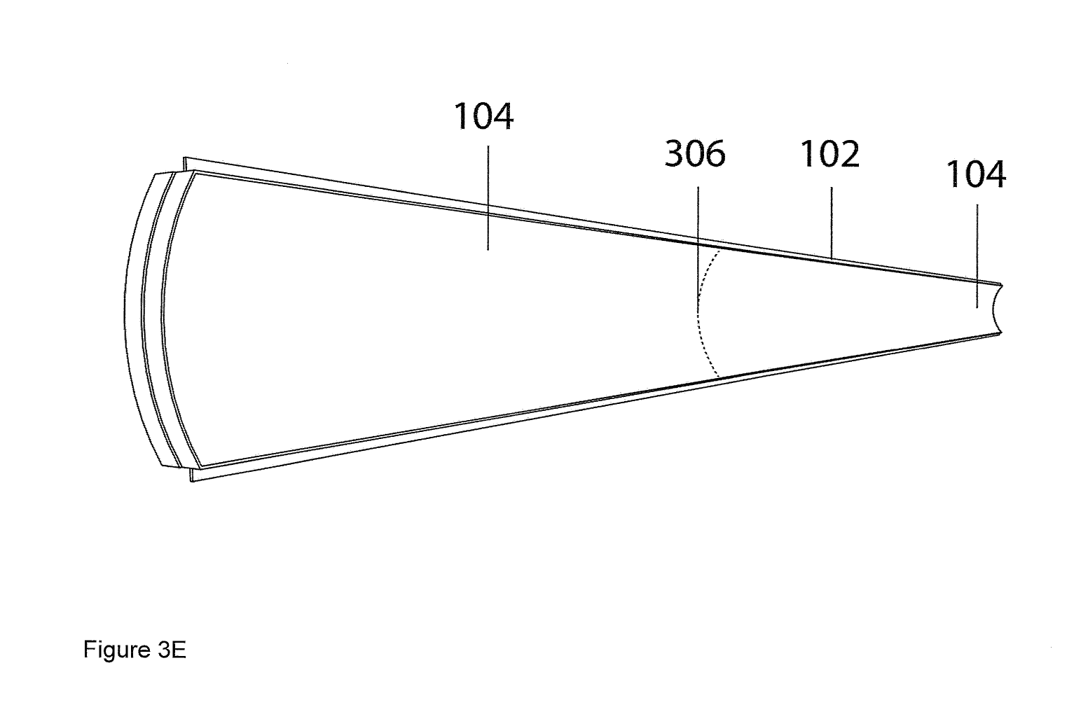

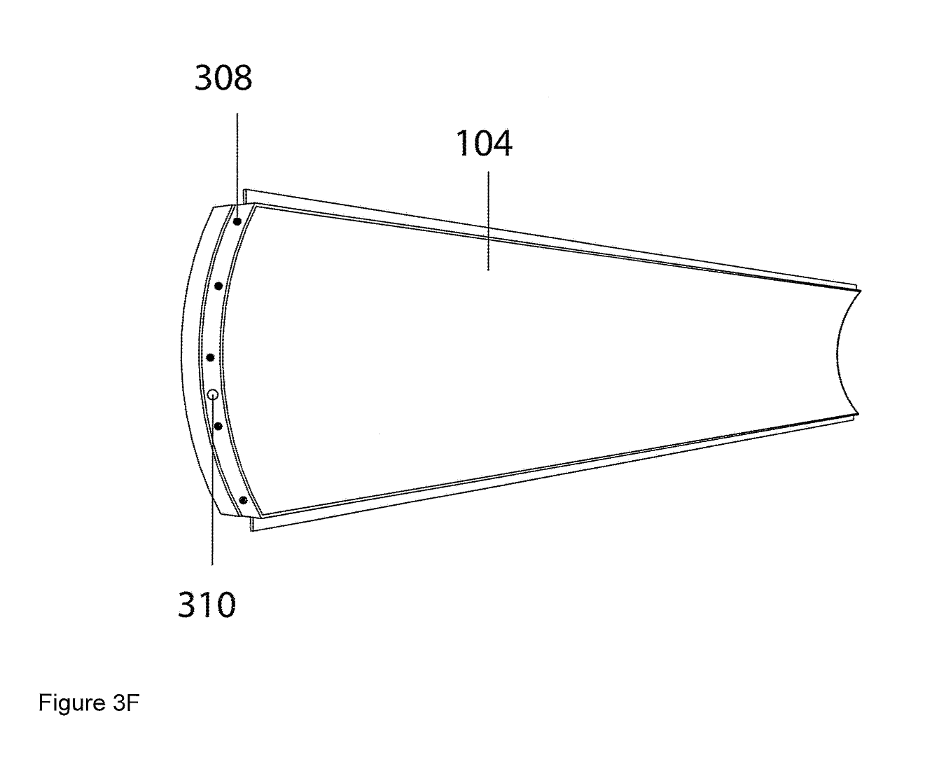

FIGS. 3A through 3E provide various representations of a preferred digital display for use with the present invention, although the actual display size may vary depending on the design of the transit vehicle and advertising trends. FIG. 3A shows the frontal view of a digital display 104. In a preferred embodiment, the digital display is 71 inches, measuring 70 inches in length and 11 inches in height, which is a current standard size of two adjacent advertisement commonly used on transit vehicles. The side view of the digital display 104 in FIG. 3B shows that the display is convex. In a preferred embodiment, the height of the viewing area is 11 inches and the total height of the display is 12 inches. FIG. 3C provides a top view of the convex display 104, which in a preferred embodiment, has an overall depth of approximately 4 inches. The use of a flat-screen display 104 would provide a smaller overall depth.

FIG. 3D provides a perspective view of a concave digital display 104. Preferred, but optional, features of the display include one or more digital cameras 300 for use in collecting analytic data, NFC touchpoint 302, and low light/auto-dimming sensor 304. As depicted in FIGS. 3E and 3F, adjacent displays 104 can be designed to fitted together to provide a seamless appearance (306) to transit riders by eliminating framing that it standard on most standard types of displays. To facilitate the connection of adjacent screens, securing connectors 308 and screen media connectors 310, which may be any suitable connector for transmitting data between displays, may be placed on the edges of the displays. Connectors 308 and 310 can alternatively be located on the rear of the displays. An alternative embodiment of the digital display 104 need not include screen media connectors 310 but instead information to be displayed may be transmitted to the displays 104 by means of wireless technology such as Wi-Fi™ 802.11 b/g/n/ac, bluetooth or other wireless technology. In the case of this alternative embodiment, display 104 will include appropriate receivers and other hardware components for receiving such wireless transmissions. When the displays 104 of an array 102 are connected in a manner providing a seamless appearance, advertisements may travel along array 102 rather than remaining in a static position.

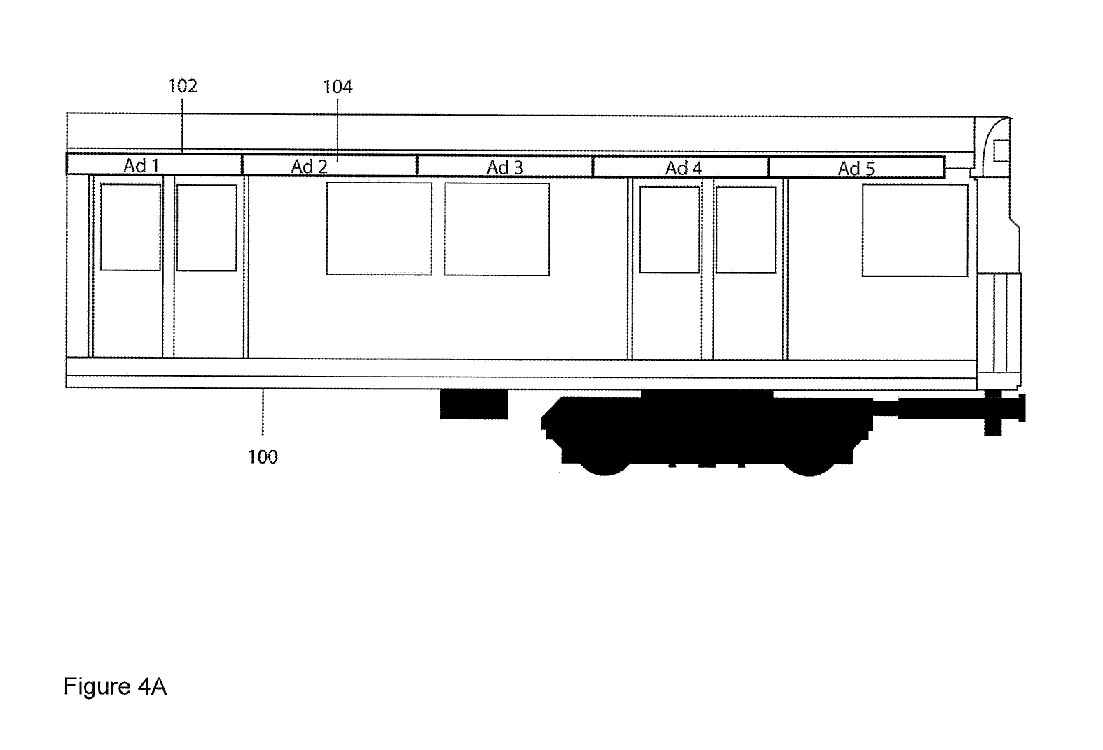

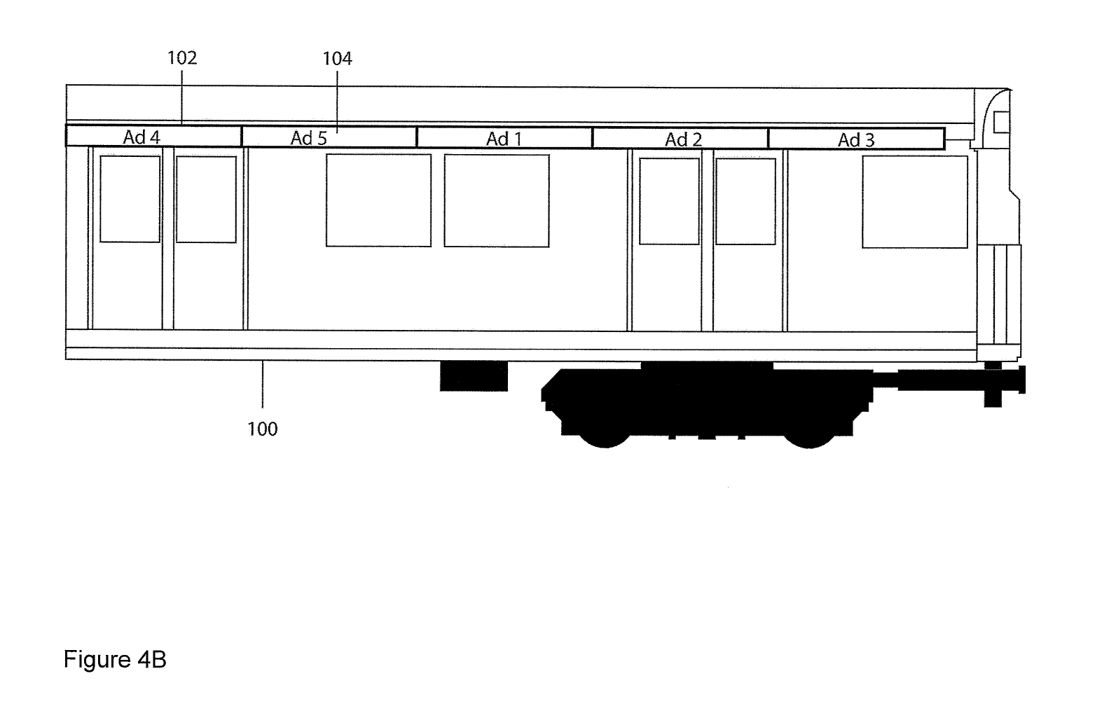

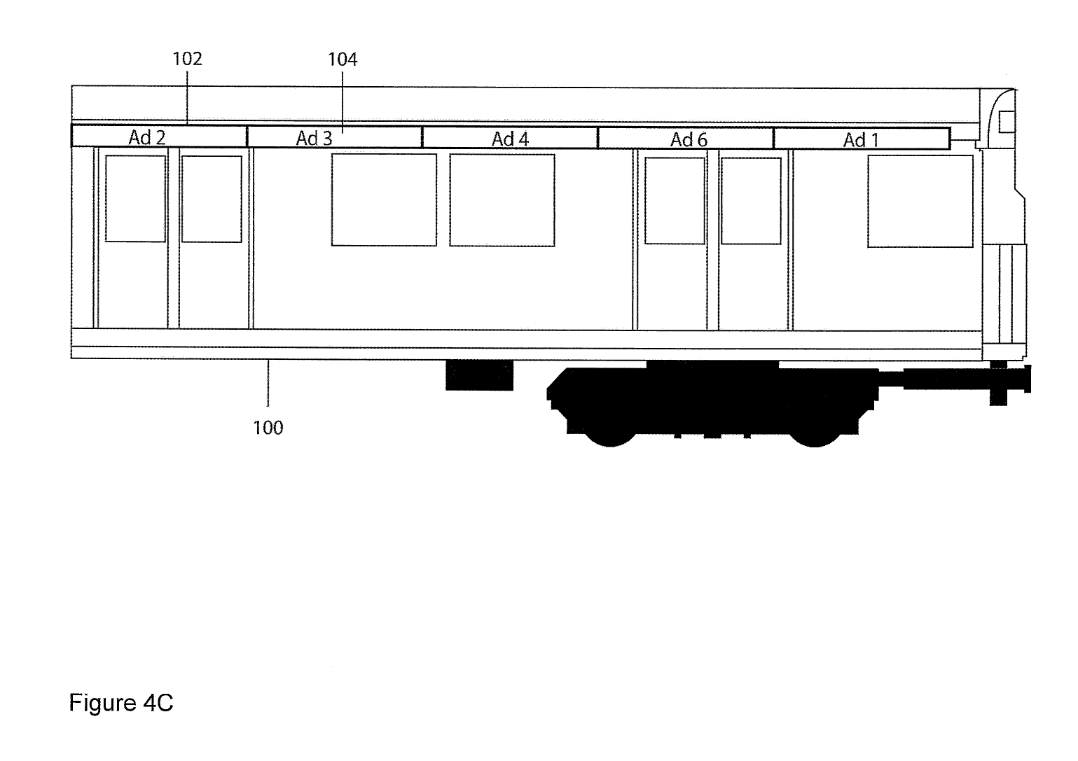

FIGS. 4A through 4C provide a section view of the advertisements displayed on the individual digital displays 104 of array 102 on transit car 100 over a period of time. As depicted in FIG. 4A, initially, array 102 displays Ad 1 through Ad 5 on five individual digital displays 104 within transit vehicle 100. FIG. 4B depicts the same vehicle 100 further along its route. Over the passage of time and depending on the current geographical location of the vehicle, the digital displays 104 on which each of Ad 1 through Ad 5 is displayed has been altered to allow riders on transit vehicle 100 to view different advertisements throughout their ride on the vehicle. FIG. 4C depicts the same transit vehicle 100 after further progression along its route. After the further passage of time and depending on the new current location of the vehicle, the digital display 104 on which each of Ad 1 through Ad 4 is displayed has again been altered on array 102. Ad 5 has been substituted with Ad 6 since the geographical location associated with Ad 5 no longer corresponded with the geographic location of transit vehicle 100 along its route.

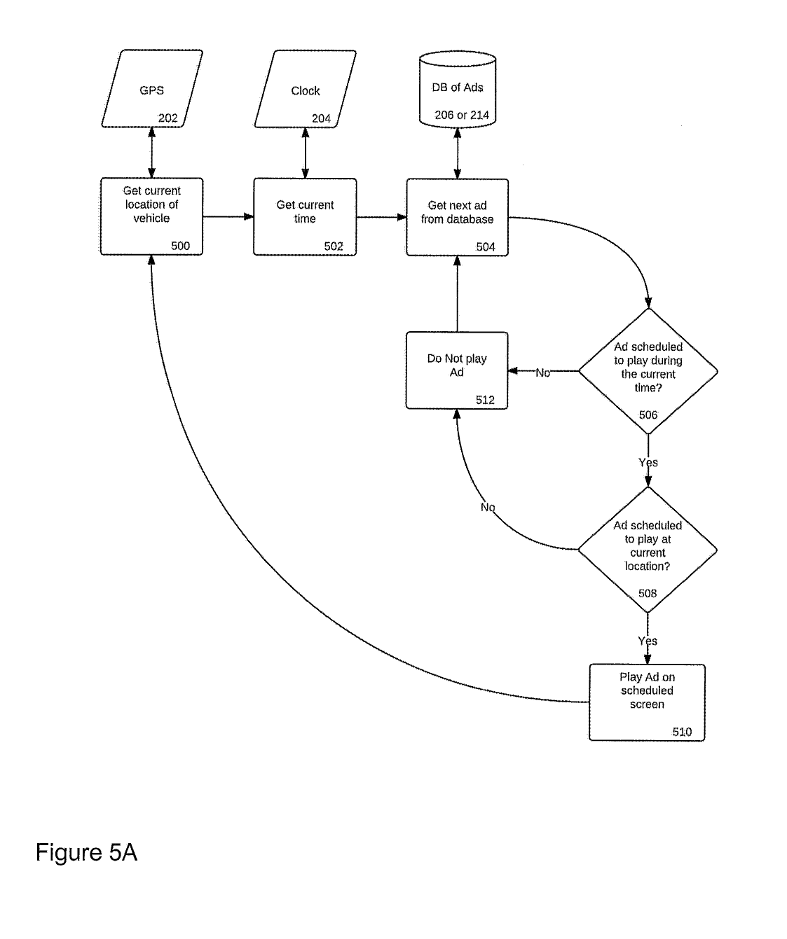

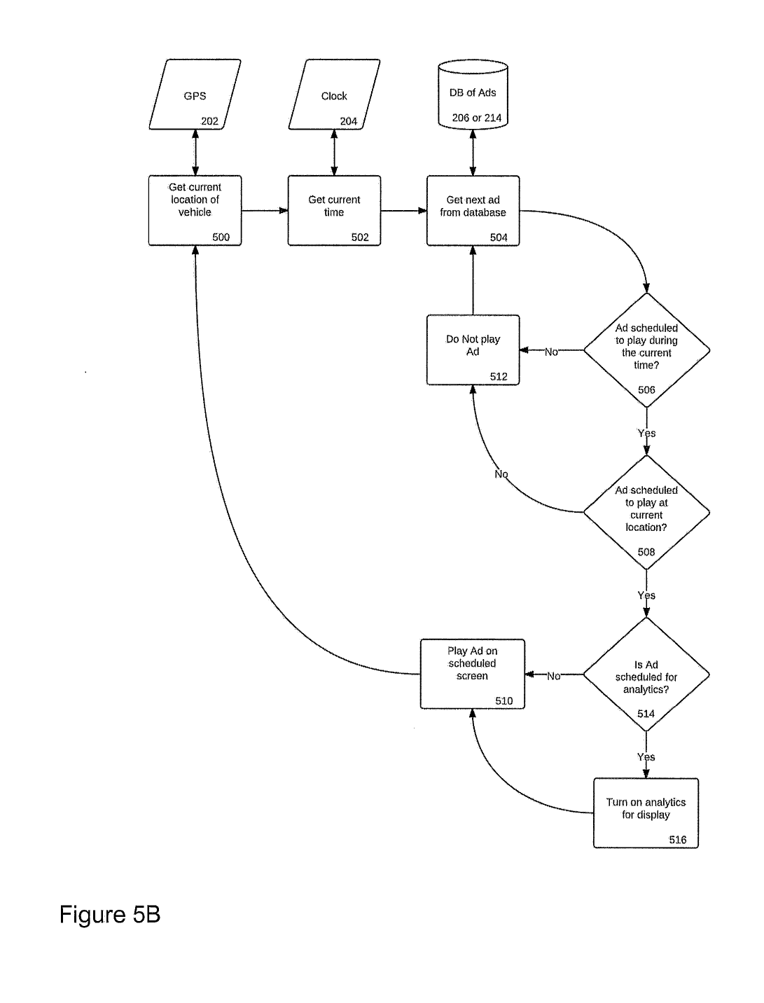

FIG. 5A provides a schematic of an advertisement scheduling diagram that can be used with the preferred system of the present invention. As the transit vehicle 100 travels on its route, the present geographical location of the vehicle 500 is transmitted by GPS 202 to the media player 200. The media player 200 also receives the current time 502 from a clock 204 (integrated within media player 200, within control centre 210, or as a separate device within the vehicle). The media player 200 then consults the advertisement database, which can be either a local database 206 located on the transit vehicle or a remote database 214 located in a control centre 210, to select the advertisement to be displayed 504 by comparing the current vehicle location and time with corresponding criteria associated with each advertisement. After the advertisement has been selected from the advertisement database 504, the media player 200 confirms that the advertisement is one that can be scheduled to play during the current time 506 and within the current location of the vehicle 508. If the current time and location are within allowable limits of the time and location criteria associated with the advertisement, then the media player 200 causes the advertisement to be played on one or more of the digital displays 510 within the vehicle 100. However, if the current time and/or the current location are outside of the allowable limits of the time and location criteria associated with the advertisement, the media player 200 will not cause the advertisement to be played on the digital displays 512 and the media player 200 then selects a new advertisement 504.

Optionally, the scheduling may additionally include the collection of analytic data when an advertisement is displayed rather than either not collecting analytic data or collecting analytic data for all advertisements displayed. In FIG. 5B, after obtaining the advertisement from the database 206 or 214 (504) and confirming that it is scheduled to be displayed at the current time and location (506 and 508), media player 200 accesses the scheduling information 514 to determine if analytic data is to be collect while the advertisement is displayed. If analytics are not scheduled, the advertisement is displayed 510. If analytics are scheduled 516, the analytic, data collection is initiated and the advertisement is displayed 510. When a new advertisement is displayed following a further iteration of the method, the collection of analytic data is halted.

After an advertisement has been selected and the selected advertisement has been displayed on the digital displays 104 for a specified period of time, the advertisement may be refreshed by re-initiating and repeating the sequence (500). The sequence may be repeated for each digital display within the transit vehicle at the same time or at staggered times (i.e., different digital displays 104 show a particular advertisement at different time intervals) based on either default run times per advertisement or on advertiser selected run-time. Further, each of the digital displays 104 may have different schedules showing different advertisements at one given time, or alternatively, groups of digital displays 104 may play the same advertisement at the same time.

In addition to displaying location-based or targeted advertisements according to an algorithm or sequence such as depicted in FIGS. 5A and 5B, the digital displays 104 may also display default non-location-based or targeted advertisements in addition to, or instead of, the location-based or targeted advertisements.

In addition to providing the above-described preferred systems for providing location-based advertising content in transit vehicles 100, a further preferred aspect of the present invention also provides methods of providing advertisements on transit vehicles 100 in which the advertisement selected to be displayed is dependent on the present geographical location of the vehicle 100.

With reference to FIGS. 5A and 5B, a method for displaying advertisements on digital displays 104 with a transit vehicle 100 comprises:
(a) Determining the current time 502 and geographical location 500 of the transit vehicle 100;
(b) Accessing a database of advertisements 206 or 214 and associated scheduling information to select an advertisement whose associated scheduling information corresponds to the current time and location of the transit vehicle 504, 506 and 508;
(c) Displaying the selected advertisement on one or more digital displays 104 (510) within the transit vehicle 100 for a specified period of time depending on the scheduling information obtained from the database 206 or 214;
(d) After the specified period of time has passed, repeating steps (a) through (c).

The preferred method of the present invention may include option steps, such as:
(a) Causing the selected advertisement to be displayed on different digital displays 104 within the transit vehicle 100 during the specified period of time so as to rotate the location within the vehicle 100 of the advertisement being displayed within an array of digital displays 102 (see FIGS. 4A, 4B and 4C, and the associated description); or
(b) Collecting and optionally storing analytic data regarding the riders of the transit vehicle 100 viewing an advertisement being displayed on one of the digital displays 104, and then transmitting the collected and/or stored analytic data to the advertiser.

A further aspect of the present invention is a method by which an advertiser or a controller of the remote control centre 210 can schedule advertisements to be displayed in one or more transit vehicles comprising:
(a) Allowing the advertiser or controller to access a central media database 214 containing stored advertisements;
(b) Associating with each of the stored advertisements criteria corresponding to a geographic area and time range and storing the criteria on the central media database 214;
(c) Transmitting the stored advertisements and associated criteria to a local media database 206 located on a transit vehicle 100;
(d) Determining the current geographical location and time of the transit vehicle 100;
(e) Selecting an advertisement from the local media database 206 whose associated criteria correspond to the current location and time of the transit vehicle 100; and
(f) Causing the selected advertisement to be displayed on one or more digital displays 104 located within the transit vehicle 100 when the transit vehicle 100.

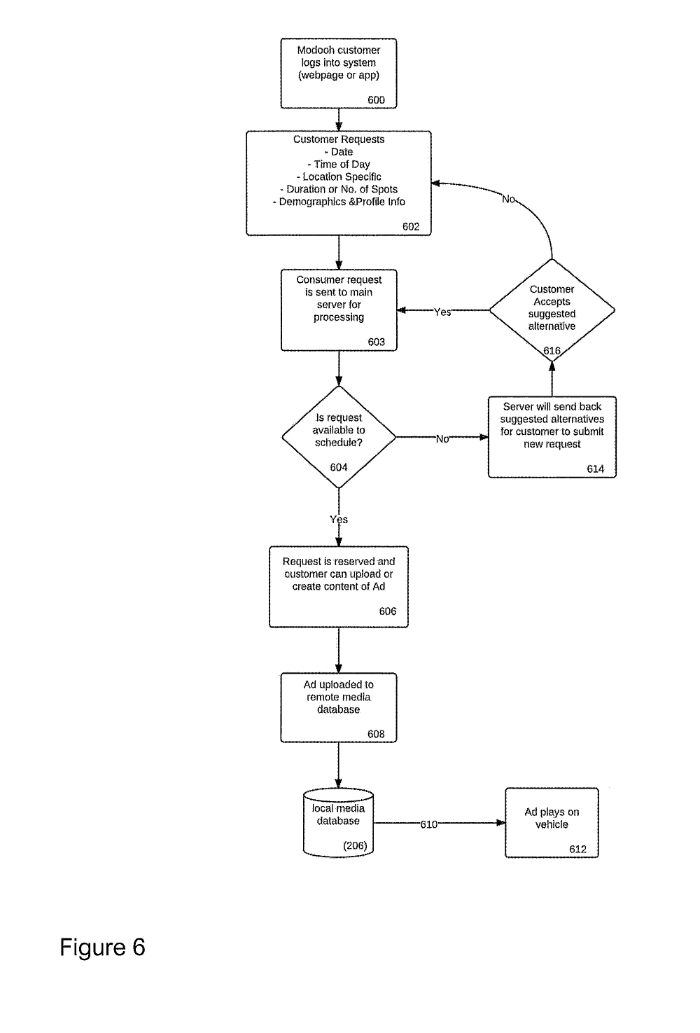

FIG. 6 provides a schematic of a client-based scheduling process that may be used with the preferred system of the present invention. A client (or agent controlling the advertising for a transit vehicle or fleet of transit vehicles) first accesses control centre 210, for example, via a webpage, app, or other computer interface 600. The client then selects the dates, times, locations (either a portion of one or more transit route or geographic area through which transit vehicles travel), duration and/or frequency for the advertisement to be displayed 602. These scheduling parameters are sent to the main server for processing 603, and the control centre then determines whether the requested scheduling parameters are available 604. If advertisement space is available 606, the advertisement is scheduled and the client can select an advertisement already stored on the media database 214 or the client can upload a new advertisement 608 to the media database 214. Alternatively, if an advertisement has not been previously prepared, the client can prepare an advertisement through the webpage, app or other computer interface used to access the control centre 210. If the requested scheduling parameters are not available, the control centre sends alternative parameters to the client (614), which the client may accept or decline (616). If the suggested parameters are accepted, the request is sent to the control centre for scheduling (604 and 606); if the suggested parameters are not accepted, the client may enter new parameters (602). After the advertisement has been scheduled 608 and the advertisement is stored in the media database 214, the advertisement can then be transmitted to one or more local media databases 206 located on transit vehicle 100 selected to display the advertisement 610. At the appropriate times and/or geographical positions of the transit vehicles 100, the advertisement is displayed on one or more digital displays 104 (612).

The preferred systems and methods of the present invention are illustrated in the following non-limiting examples describing various aspects of the embodiments described herein. It will be apparent to the skilled reader that various alterations to the system, for example, the nature, size and resolution of the digital displays and the types and models of the various components (for example, server processors, video cards, memory types, database sizes, wireless technology standards, etc.), may be made when implementing or using the preferred system of the present invention without departing from the scope or intent thereof.

### Example 1

### Installation of a Location-Based Advertising System within Fleet of Transit Vehicles

A transit authority outfits its fleet of buses with the preferred system of the present invention. Within each bus is installed a media player and two arrays of digital displays, each comprising a continuous band of individual digital displays running the majority of the length of the bus above the windows, and whose displayed content is controlled by the media player. The media player on each bus communicates wirelessly with a remote control centre located within the headquarters of the transit authority.

For the 40-foot buses in the fleet, each of the arrays of digital displays consists of 6 LED displays, each measuring 70 inches in length, 11 inches in width and 2 inches in depth, and having a resolution of 1560×720 pixels and a 5000:1 contrast ratio. The LED displays are located so as to provide the appearance of a seamless band, or single display, running the length of each side of the bus. Each of the LED displays is also equipped with auto-dimming capability to adjust the brightness of the displays throughout the day. Further, each of the LED displays within the array are interconnected through RS-232 command interface connections, with each array in turn being connected to the media player.

The media player located on the bus comprises a central processing unit, random access memory, a solid state hard drive, and graphic processors to control the content of each digital display. Each media player also includes Wi-Fi™ communication ability to allow communication with the remote control centre, an internal clock, and means to obtain the present location of the bus using GPS technology. The solid state hard drive of the media player houses the local media database in which the advertisements to be displayed and their associated scheduling information are stored.

As a default setting, the remote control centre updates the local media database on the bus before the bus enters service each day to ensure that the advertisement content and associated scheduling information is current for the assigned route. If updates are made to the remote media database throughout the day, the updates may then be transmitted to the relevant buses by wireless communication. If, during the course of a day, a bus's route is changed, the remote control centre then updates via wireless communication the local media database on the bus to ensure that correct advertisements for that geographic area and timeframe are available for display within the bus.

As each bus travels along its route, the media player selects advertisements to be displayed on each digital display located in the bus based on the scheduling information stored on the local media database, which provides information on the geographical area and time of day in which an advertisement can be played, the specified length of time for which an advertisement can play, and the number of digital displays in the bus on which the advertisement is to be displayed. As one of the scheduling criteria expires, for example, the bus moves outside the designated geographic area for an advertisement or the specified time for which an advertisement may be displayed expires, a new advertisement is selected from the media database based on the current location of the bus and current time. In order to maximize the number of riders on the bus that can see a particular advertisement over the course of their ride, the selected advertisements are displayed on different digital displays at different time intervals.

### Example 2

### The Use of Analytic Software in Conjunction with the Preferred System of the Present Invention

Each of the digital displays described in Example 1 additionally comprises two digital cameras used to collect analytical data using the INTEL® AIM Suite. When an advertiser has indicated that they wish to obtain analytic data regarding the riders viewing their advertisement on the bus, data is collected by the digital cameras when the specified advertisement is displayed on one of the digital displays. When advertisements are cycled throughout the digital displays along an array, the cameras for a given digital display are activated or de-activated as required so that analytical data is collected through each digital display on which the advertisement is shown. The collected analytic data is stored by the media player and after a specified period of time, the stored analytic data relating to the advertisement is transmitted to the advertiser.

### Example 3

### The Use of Analytic Software as an Additional Advertisement Selection Criterion

In addition to the collection of analytic data for transmission to the advertiser, the digital cameras described in Example 2 may also be used to collect analytical data regarding the riders observing or within range of a specific digital display. When there are more advertisements stored and available for a given geographic area than there are digital displays within the bus, analytic data can be used to further select which of the advertisements are to be played based on the present riders viewing or in the vicinity of a digital display. Thus, if the analytic software determines that the majority of riders within a digital display are from a specific group, advertisements can be further selected that are of more interest to that specific group. This analytic data may also be used to override the standard advertisement rotation to focus particular types of advertisements on specific digital displays so as to target the specific riders in the vicinity of those specific digital displays.

### Example 4

### Targeting Riders Approaching a Specific Location During a Specific Time

A restaurant is located within a city's downtown core. While this establishment regularly has walk-in traffic during the lunch hour, the level of walk-in traffic during the dinner hours is decreased as potential customers are returning home after the work day. By using the preferred system and method of the present invention, the owner of the restaurant can access the remote media database of the central control centre, enter a timeframe, for example, during the morning and evening rush hours when target customers are riding transit vehicles passing by the restaurant, and causing their advertisement to be displayed when the transit vehicles are approaching or in the vicinity of the restaurant's location. Within their advertisement, the owner of the restaurant may also include a downloadable coupon that can be scanned from the digital display on the bus by a rider using a smartphone and that can be later used at the restaurant that day for a discount on the cost of a meal.

### Example 5

### The Use of Digital Displays to Provide Transit Connection Information

A transit rider's usual afternoon travel route home include a subway ride from Station C to Station L and then a bus ride on Bus #87a. Upon entering the subway car, the rider sits down and begins viewing the advertisements on the digital displays. As the subway approaches Station L, a notification appears at the bottom of displays indicating that there has been a delay on bus route #87a, and that service is expected to be restored in half an hour. The rider, having been informed of the delay, can now choose if he would like to wait for the restored service or take an alternate route home. By scanning a NFC tag on the display, the rider is able to download a mobile app for the transit system which, once installed, provides more details on the transit system and the available alternate routes.

Rather than finding an alternate route, the rider can also visit one of the many stores, restaurants and bars in the immediate vicinity of Station L, whose advertisements are scheduled to play on the subway's displays whenever buses on routes departing from Station L are delayed by more than five minutes. When the transit system provides the warning about the delay for buses on route #87a, these advertisements are triggered to play as the subway approaches Station L.

### Example 6

### Energy Savings Through the Replacement of Traditional Static Advertising Displays with Digital Displays

A municipal transit system operates of fleet of 2,800 vehicles, with each vehicle displaying 40 advertisements on traditional 35 inch by 11 inch styrene sheets. Over the course of a one year period, the advertisements on each transit vehicle are changed ten times, resulting in the generation and disposal of 1,120,000 advertisements per year. Depending on the thickness of the styrene advertisements, for example, 0.02 inches or 0.03 inches, each advertisement weight between 0.4 and 0.6 pounds. Thus, over the course of one year, providing advertisements on the transit fleet leads to the generation of 224 to 336 tons of styrene waste per year. By retrofitting their fleet of transit vehicles with the digital display-based system of the present invention, the transit system is able to divert this waste material from the local landfill each year.

Within the same fleet of transit vehicles, each vehicle also contains 40 florescent lamps and 10 ballasts, with each ballast weighting 16 pounds. On a yearly basis, the transit system replaces approximately 112,000 florescent bulbs, from which the mercury must be removed before ultimate disposal, and 9,500-14,000 ballasts, weighing 76-112 tons. By retrofitting their fleet of transit vehicles with the digital display-based system of the present invention also having LED lighting bands, and removing the existing florescent lighting, the transit system is able to divert this waste material from the local landfill each year.

Further to the diversion of waste from the landfill, the transit system also benefits from lower energy consumption owing to the switch from florescent to LED lighting. The power consumption associated with one ballast for the florescent lighting used in transit vehicles is approximately 356 Watts per hour, or 3,560 Watts per hour per vehicle. In contrast, the use of a LED digital displays with light bands use approximately 2,285 Watts per hour (assuming a twenty 70 inch by 11 inch displays with a 70 inch by 1 inch light band per vehicle, and a power consumption of 0.136 Watts per square inch), which is 64% of the power consumed by a florescent bulb. Further energy savings are realized when an OLED display is used, since OLED displays use approximately 25% less power than LED displays. Thus power consumption per vehicle would be reduced to approximately 1714 Watts per hour, which is only 48% of the power consumed by florescent bulbs. When considered over the transit system's 2,800 vehicle fleet, replacing the florescent bulbs currently used in transit vehicle with the arrays of digital displays of the present invention results in a 4.6-5.15 million Watts per hour energy savings.

Therefore, by retrofitting its fleet of transit vehicles with the arrays of digital displays of the present invention, the transit system, in addition to providing an improved advertising medium to the benefit of both transit riders and advertisers, also reduces the amount of solid waste it generates per year and the energy consumption of its fleet of vehicles.

It is to be understood that while certain embodiments the present invention have been described and illustrated, the present invention is not to be limited to the specific form or arrangement of parts herein described and shown. It will be apparent to those skilled in the art that various changes or modifications may be made without departing from the scope of the invention and the present invention is not to be considered limited to what is shown in the drawings and described in the specification.

1. A system for providing location-based information on transit vehicles, the system comprising:
(a) at least one digital display located in the transit vehicle and viewable by passengers in the transit vehicle, the at least one digital display capable of displaying the location-based information;
(b) at least one rider-interaction feature incorporated into the at least one digital display to allow the passengers in close proximity to the at least one digital display that incorporate the at least one rider-interaction feature to obtain supplementary information related to the displayed location-based information through the direct wireless transfer of information between the at least one digital display and a mobile device operated by one of the passengers on the transit vehicle;
(c) a media player to control the information that is displayed on the at least one digital display; and
(d) a location sensing device located on the transit vehicle to communicate the geographical location of the transit vehicle to the media player,
wherein the media player selects the location-based information to be displayed on the at least one digital displays depending on the geographical location of the vehicle.

2. The system of claim 1, wherein the at least one digital display has a height in the range of 10 inches to 14 inches and a length in the range of 30 inches to 75 inches.

3. The system of claim 1, wherein the at least one digital display has a concave-shaped front face when viewed by the passengers.

4. The system of claim 1 comprising at least two digital displays arranged in a length-wise fashion.

5. The system of claim 1, wherein the at least one digital display has at least one digital camera for the collection of analytic data regarding the passengers currently viewing the location-based information displayed on the at least one digital display and wherein the system further comprises storage means for storing the collected analytic data.

6. The system of claim 5, wherein the media player selects the location-based information to be displayed on the at least one digital display depending on the geographical location of the vehicle and the collected analytic data regarding the passengers currently viewing the one or more digital displays.

7. The system of claim 1, comprising an array of at least two digital displays, the array of digital displays capable of displaying the location-based information on a rotating basis amongst the digital displays in the array for a specified period of time.

8. The system of claim 1, wherein the system is capable of providing time-based information, and wherein the system further comprises a clock that provides a current time and the media player selects the time-based information to be displayed on the at least one digital display depending on the current time.

9. A system for displaying location-based information on transit vehicles, the system comprising:
(a) an array comprising at least two digital displays arranged lengthwise within the array, wherein the array is located in the transit vehicle,
(b) each of the at least two digital displays is viewable by passengers in the transit vehicle and is capable of displaying the location-based information;
(c) at least one rider-interaction feature incorporated into at least one of the digital displays to allow the passengers in close proximity to the digital displays that incorporate the at least one rider-interaction feature to obtain supplementary information related to the displayed location-based information through the direct wireless transfer of information between the display and a mobile device operated by one of the passengers on the transit vehicle, and optionally through at least one touch capable interface on the at least one digital display;
(d) a media player to control the location-based information that are displayed on the at least two digital displays;
(e) a location sensing device located on the transit vehicle to communicate the geographical location of the transit vehicle to the media player,
wherein the media player selects the location-based information to be displayed on the at least two digital displays depending on the geographical location of the vehicle.

10. The system of claim 9, wherein the at least two digital displays have a height in the range of 10 inches to 14 inches and a length in the range of 30 inches to 75 inches.

11. The system of claim 10, wherein the at least two digital displays have a concave-shaped front face when viewed by the passengers.

12. The system of claim 9, wherein the at least two digital displays each have at least one digital camera for the collection of analytic data regarding the passengers currently viewing the information displayed on the at least two digital displays, and wherein the system further comprises storage means for storing the collected analytic data.

13. The system of claim 12, wherein the media player selects the location-based information to be displayed on the at least two digital displays depending on the geographical location of the vehicle and the collected analytic data regarding the passengers currently viewing the one or more digital displays.

14. The system of claim 9, wherein the system is capable of providing time-based information, and wherein the system further comprises a clock that provides a current time and the media player selects the time-based information to be displayed on the at least two digital displays depending on the current time.

15. A method of displaying location-based information on at least one digital display located within a transit vehicle and viewable by passengers in the transit vehicle, the method comprising:
(a) determining with at least one processor and a location sensing device located on the transit vehicle the current geographical location, and optionally determining using a clock the current time, of the transit vehicle;
(b) accessing with the at least one processor a database of location-based information and associated scheduling information to select location-based information having scheduling information that is associated with the current geographical location, and optionally the current time, of the transit vehicle;
(c) displaying the selected location-based information on the at least one digital display for a specified period of time depending on the scheduling information associated with the selected location-based information; and
(d) providing at least one rider-interaction feature incorporated into the at least one digital display to allow the passengers in close proximity to the at least one digital display that incorporates the at least one rider-interaction feature to obtain supplementary information related to the displayed location-based information through an interface providing direct wireless transfer of information between the at least one display and a passenger in the transit vehicle.

16. The method of claim 15, wherein the at least one digital display is configured in an array of digital displays and the selected location-based information is displayed on the array of digital displays on a rotating basis amongst the digital displays in the array for a specified period of time depending on the scheduling information associated with the selected location-based information.

17. The method of claim 15, further comprising the steps of collecting, and optionally storing, analytic data regarding the passengers viewing the selected location-based information on the at least one digital display that is collected from at least one digital camera associated with each digital display, and transmitting the collected and optionally stored analytic data to a user and selecting the location-based information to be displayed on the at least one digital display depending on the geographical location of the vehicle and the collected analytic data regarding the passengers currently viewing the at least one digital display.

18. The method of claim 15, wherein the at least one digital display has a height in the range of 10 inches to 14 inches and a length in the range of 30 inches to 75 inches.

19. The method of claim 15, wherein the at least one digital display has a concave-shaped front face when viewed by the passengers.

20. The method of claim 15, wherein the at least one digital display is configured in an array of digital displays and the selected information is displayed on the array of digital displays.

21. The system of claim 1 wherein the supplementary information is obtained through the transfer of information through a wireless interface selected from WI-FI™, bluetooth, near-field communications and combinations thereof.

22. The system of claim 9 wherein the supplementary information is obtained through the transfer of information through a wireless interface selected from WI-FI™, bluetooth, near-field communications and combinations thereof.

23. The method of claim 15 wherein the supplementary information is obtained through the transfer of information through a wireless interface selected from WI-FI™, bluetooth, near-field communications and combinations thereof.

24. The system of claim 1, wherein the supplementary information includes quick response codes, TAG codes, UPC-type barcodes, links to websites, information on store locations, downloadable coupons and combinations thereof.

25. The system of claim 9, wherein the supplementary information includes quick response codes, TAG codes, UPC-type barcodes, links to websites, information on store locations, downloadable coupons and combinations thereof.

26. The method of claim 15, wherein the supplementary information includes quick response codes, TAG codes, UPC-type barcodes, links to websites, information on store locations, downloadable coupons and combinations thereof.
